(19) United States
(12) Patent Application Publication
(10) Pub. No.: US 2026/0233701 A1
(43) Pub. Date: Aug. 13, 2026

(54) SYSTEM AND METHOD FOR ASSISTING RECOVERY OF A COMMUNICATION CONNECTIVITY IMPAIRED STOLEN VEHICLE

(71) Applicant: GM GLOBAL TECHNOLOGY OPERATIONS LLC, Detroit, MI (US)

(72) Inventors: Ryan J. Baik, Troy, MI (US); Luke J. Popiel, Oxford, MI (US); Aqueel Husain, Troy, MI (US); David Adams, Troy, MI (US); Suchinder K. Govindan, Farmington Hills, MI (US)

(73) Assignee: GM GLOBAL TECHNOLOGY OPERATIONS LLC, Detroit, MI (US)

(21) Appl. No.: 19/052,394

(22) Filed: Feb. 13, 2025

(51) Int. Cl. B60R 25/104; B60R 25/10; B60R 25/102; B60R 25/33; H04W 4/02; H04W 4/14; H04W 4/44

(52) U.S. Cl. CPC B60R 25/104; B60R 25/102; B60R 25/33; H04W 4/025; H04W 4/14; H04W 4/44; B60R 2025/1016; B60R 2325/207

(57) ABSTRACT

A method of assisting recovery of a communication connectivity impaired vehicle includes detecting, by a remote vehicle service provider, a loss of the vehicle's global positioning system (GPS) connectivity. The method also includes identifying, via the remote vehicle service provider, the vehicle as having been stolen. The method additionally includes sending, by the remote vehicle service provider, a long-lived short message service (SMS) communication to a mobile communication provider in response to the identified vehicle theft. The method also includes attaching, by the mobile communication provider, the long-lived SMS communication to a network of cellular towers. The method additionally includes transmitting, via one of the cellular towers, the long-lived SMS communication to a vehicle's electronic controller when the vehicle is within transmitting range of the subject tower. The method also includes receiving, via the vehicle's controller, the long-lived SMS communication and triggering an emergency vehicle action in response thereto.

### INTRODUCTION

The present disclosure relates to a system and a method for assisting recovery of a communication connectivity impaired stolen vehicle.

Vehicle theft is a type of a property crime that aims to deprive the vehicle's rightful owner of the vehicle's use without the owner's consent. Different categories of vehicle theft may include taking of an unattended vehicle without a key via removing a parked vehicle either by breaking and entry, followed by hotwiring or other tampering methods to start the vehicle, or towing.

Vehicle theft may also include removal of an unattended vehicle left with the keys visible and sometimes the engine idling, or theft of a vehicle offered for sale during what the thief represents as a test drive. Carjacking is another type of vehicle theft that includes taking a vehicle by force, or threat of force, against its owner or operator. A contemporary type of vehicle theft may include interception and extension of signal from the owner's key or key fob tied to the vehicle's keyless entry and start system with the help of a signal amplifier. This action permits the thief to open the vehicle's door, actuate the start button, and drive away without triggering the vehicle's security system.

To aid stolen vehicle recovery, some vehicles may be equipped with electronic tracking systems or devices designed to communicate the location of the vehicle to local law enforcement or a private company. However, a knowledgeable thief may disconnect the vehicle's tracking system to sever vehicle communication with external sources and thwart its recovery.

### SUMMARY

A method of assisting recovery of a communication connectivity impaired vehicle having an electronic controller includes detecting, by a remote vehicle service provider configured to maintain communication with the vehicle's electronic controller via a global positioning system (GPS), a loss of the vehicle's GPS connectivity. The method also includes identifying, via the remote vehicle service provider, the vehicle as having been removed from last known location without the vehicle owner's authorization, i.e., stolen. The method additionally includes sending, via the remote vehicle service provider, a long-lived short message service (SMS) communication to a mobile communication provider in response to the identified removal of the vehicle. The method also includes attaching, via the mobile communication provider, the long-lived SMS communication to a network of cellular towers. The method additionally includes transmitting, via one of the cellular towers, the long-lived SMS communication to the vehicle's electronic controller when the vehicle is within transmitting range of the subject cellular tower. The method also includes receiving, via the vehicle's electronic controller, the long-lived SMS communication and triggering, via the vehicle's electronic controller, an emergency vehicle action in response to the received long-lived SMS communication.

The long-lived SMS communication may use a maximum time to live as active communication set by the mobile communication provider.

The method may additionally include identifying, by the remote vehicle service provider, geographic location of the cellular tower having transmitted the long-lived SMS communication to the vehicle's electronic controller. In such an embodiment, the method may further include communicating, by the remote vehicle service provider, the geographic location of the subject cellular tower to a vehicle searching authority, such as a law enforcement agency.

The long-lived SMS communication may include instructions for the emergency vehicle action internal and/or external to the vehicle.

Triggering the emergency vehicle action internal to the vehicle may include activating at least one of a high-volume noise and displaying a visual message via an infotainment system of the vehicle.

Triggering the emergency vehicle action external to the vehicle may include activating at least one of honking a horn of the vehicle and activating a flashing light pattern via a lighting system of the vehicle.

The method may additionally include establishing, by the remote vehicle service provider, an aggressive packet connection with the vehicle's electronic controller following receiving thereby the long-lived SMS communication.

The aggressive packet connection may include instructions for an impaired vehicle operation. In such an embodiment, the method may further include triggering, via the vehicle's electronic controller, the impaired vehicle operation in response to the aggressive packet connection being established.

The method may additionally include receiving communication, via the remote vehicle service provider from the vehicle searching authority, indicative of the vehicle having been recovered. In such an embodiment, the method may further include communicating, by the remote vehicle service provider to the vehicle's electronic controller, instructions to reverse the triggered emergency vehicle action and the impaired vehicle operation when the vehicle has been recovered. The vehicle's electronic controller would then reverse the above in response to the subject communication.

The loss of the vehicle's GPS connectivity may be caused by a cellular antenna of the vehicle being rendered inoperative.

A system for assisting recovery of a connectivity-impaired vehicle having an electronic controller configured to be in communication with a remote vehicle service provider is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a plan view of a motor vehicle having an electronic controller configured to be in communication with a remote vehicle service provider and a system for assisting recovery of the vehicle in the event the vehicle is subject to theft and its communication connectivity is impaired, according to the present disclosure.

FIG. 2 is a flow diagram of a method of assisting recovery of a communication connectivity impaired stolen vehicle using the system shown in FIG. 1, according to the present disclosure.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “top”, and “bottom”, etc., describe the orientation and/or location of portions of the components or elements within a consistent but arbitrary frame of reference, which is made clear by reference to the text and the associated drawings describing the components or elements under discussion.

Furthermore, terms such as “first”, “second”, “third”, and so on may be used to describe separate components. Such terminology may include the words specifically mentioned above, derivatives thereof, and words of similar import, and are used descriptively for the figures, and do not represent limitations on the scope of the disclosure, as defined by the appended claims. Moreover, the teachings may be described herein in terms of functional and/or logical block components and/or various processing steps. It should be realized that such block components may include a number of hardware, software, and/or firmware components configured to perform the specified functions.

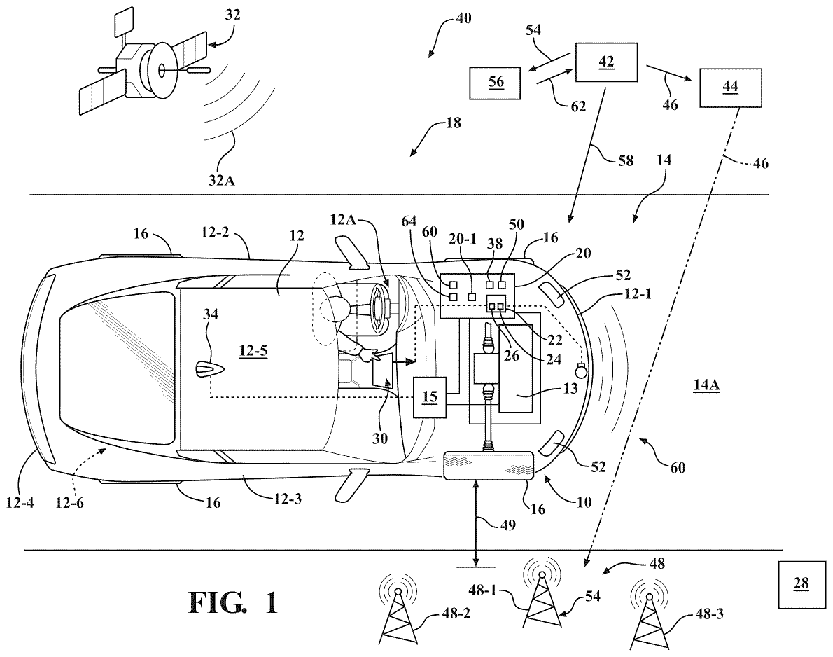

Referring to the drawings, wherein like reference numbers refer to like components, FIG. 1 shows a schematic view of a motor vehicle 10 having a vehicle body 12 and a powertrain 13 for propelling the vehicle. The vehicle body 12 may have a leading side or front end 12-1, a left body side 12-2, right body side 12-3, a trailing side or back end 12-4, a top side or section, such as a roof, 12-5, and a bottom side or undercarriage 12-6. The vehicle body 12 generally defines a cabin 12A for an operator and passengers of the vehicle 10. The vehicle 10 may be used to traverse a geographical area 14 with associated terrain, i.e., roads and physical objects, such as residential complexes, places of business, landmarks, sights, and attractions.

As shown in FIG. 1, the vehicle 10 may include an energy storage device 15 for providing electrical power to vehicle's systems and a plurality of road wheels 16, at least some of which receive torque generated by the powertrain 13. Although four wheels 16 are shown, a vehicle with fewer or greater number of wheels, or having other means, such as tracks (not shown), of traversing a road surface 14A or other portions of the geographical area 14 is also envisioned. The vehicle 10 may use a data gathering and processing system 18 (shown in FIG. 1) to assist the vehicle's operator with vehicle localization and guidance, for example while traversing the geographical area 14. With respect to the present disclosure, the data gathering and processing system 18 may also be used for determining real-time location of the vehicle 10 by external sources, as will be described in detail below.

The data gathering and processing system 18 includes a programmable electronic controller 20 arranged on the vehicle 10, which may be integral to a central processing unit (CPU). The controller 20 is in communication with various vehicle sensors (not shown) and may be configured to use data captured by such sensors for various purposes, such as to establish a 280-degree view of the geographical area 14, to execute perception algorithms, etc. The controller 20 includes a memory that is tangible and non-transitory. The memory may be a recordable medium that participates in providing computer-readable data or process instructions. Such a medium may take many forms, including but not limited to non-volatile media and volatile media. Non-volatile media used by the controller 20 may include, for example, optical or magnetic disks and other persistent memory.

The controller 20 also includes algorithms that may be implemented as electronic circuits, e.g., FPGA, or as algorithms saved to non-volatile memory. Volatile media of the controller 20 memory may include, for example, dynamic random-access memory (DRAM), which may constitute a main memory. Memory of the controller 20 may also include a flexible disk, hard disk, magnetic tape, other magnetic medium, a CD-ROM, DVD, other optical medium, etc. The controller 20 may be equipped with a high-speed primary clock 20-1, requisite Analog-to-Digital (A/D) and/or Digital-to-Analog (D/A) circuitry, input/output circuitry and devices (I/O), as well as appropriate signal conditioning and/or buffer circuitry. Algorithms required by the controller 20 or accessible thereby may be stored in the controller memory and automatically executed to provide the required functionality. Controller 20 may be configured, i.e., structured and programmed, to receive and process captured raw data signals gathered by the vehicle sensors.

As shown, the data gathering and processing system 18 includes a navigation module or device 22 in communication with the electronic controller 20. The navigation module 22 includes a map 24 of the geographical area 14 stored within its memory and is generally configured to establish navigation routes for guidance of the vehicle 10 through the associated terrain. The navigation module 22 may be configured to determine a navigation route 26 to a particular destination 28 through the geographical area 14, such as following a request for determination of the subject route by an operator of the vehicle 10. The controller 20 is specifically configured to access the navigation route 26 in the navigation module 22 or receive the navigation route therefrom. The navigation module 22 is generally configured to output the determined navigation route 26 and display the route using a navigation screen of the infotainment system 30 (shown in FIG. 1) arranged in the vehicle cabin 12A.

As defined herein, the data gathering and processing system 18 also includes a global positioning system (GPS) 32 having earth-orbiting satellites in communication with the navigation module 22. The navigation module 22 may be configured to receive from the GPS 32 signal(s) 32A indicative of a current position of the GPS satellite(s) relative to the vehicle 10. Specifically, the navigation module 22 employs a cellular antenna 34 mounted to the vehicle 10 and operatively connected to the electronic controller 20. The cellular antenna 34 is used for communicating with external sources (positioned remotely from the vehicle) and specifically for receiving signal(s) 32A. The navigation module 22 may be configured to use the signal(s) 32A to determine a current geographical position of the vehicle 10 relative to the geographical area 14 and then communicate to the controller 20 an electronic signal 38 indicative of the determined current geographical position. Alternatively, the electronic signal 38 communicated by the navigation module 22 to the controller 20 may be indicative of the received satellite signal(s) 32A and the controller will use the signal(s) 32A to determine the current geographical position of the vehicle 10.

Generally, each GPS satellite continuously transmits a radio signal indicative of the current time and the satellite's position. Since the speed of radio waves is constant and independent of the GPS satellite speed, the time delay between when the satellite transmits a signal and the receiver receives it is proportional to the distance from the satellite to the receiver. The navigation module 22 typically monitors multiple satellites and solves equations to determine the precise position of the vehicle 10 and its deviation from true time. The navigation module 22 generally requires a minimum of four GPS satellites to be in view for the module to compute three position coordinates and the clock deviation from satellite time.

Vehicles may be subject to theft. In other words, the owner of the vehicle 10 may be deprived of the vehicle's use when the vehicle is removed from its last known location without the vehicle owner's consent. Furthermore, communication connectivity, such as via the GPS 32, of the stolen vehicle 10 with external sources may be purposely impaired, i.e., tampered with to sever communication. Specifically, the stolen vehicle 10 may have its cellular antenna 34 deliberately damaged or disconnected to sever external communication and make the vehicle tougher to locate. As a result of the vehicle's impaired communication connectivity, recovery of the stolen vehicle 10 may be hampered. A system 40 including several cooperating resources and devices, some located within and some remotely from the vehicle, is herein disclosed for assisting recovery of such a communication connectivity impaired vehicle 10.

System 40 includes the data gathering and processing system 18 and a remote vehicle service provider 42. The vehicle service provider 42 is arranged distantly from the vehicle 10 and may include a specifically configured electronic processor and a back-office advisor to render or facilitate such services as in-vehicle safety and security, navigation, remote diagnostics, and emergency mitigation. The vehicle service provider 42 is employed to maintain communication with the vehicle's electronic controller 20 via the GPS 32, e.g., using a mobile application (such as OnStar), and a mobile communication provider or cellular service carrier 44. The vehicle service provider 42 is specifically configured, i.e., having the technical capability, organizational structure, and programming, to detect the severing of communication with the vehicle 10, such as by identifying the loss of GPS connectivity, as may be caused by the vehicle's cellular antenna 34 being rendered inoperative.

The vehicle service provider 42 is additionally configured and tasked to identify when vehicle 10 has been stolen, for example, as communicated by a stolen-vehicle police report or a phone call from the vehicle's owner. The vehicle service provider 42 is additionally configured and tasked to send a long-lived short message service (SMS) communication 46 to the mobile communication provider 44 in response to the identified vehicle theft. As understood within the context of the present disclosure, a long-lived SMS communication is a text message provided with an extended time to transmit, as compared to a standard communication protocol. The long-lived SMS communication 46 may be provided with a maximum time to live as active communication, i.e., continue to try and transmit, permitted or set by the mobile communication provider 44.

Upon receipt of the long-lived SMS communication 46, the mobile communication provider 44 is configured to attach the subject communication to a network 48 of cellular towers or base stations, such as a first, second, and third towers 48-1, 48-2, 48-3. In other words, the mobile communication provider 44 sends the long-lived SMS communication 46 to each or a select number of towers in the identified network 48. The attachment of long-lived SMS communication 46 to individual towers, permits the SMS communication to remain active for direct transmission to the identified destination for an extended or effective until canceled duration.

Each of the cellular towers in the network 48 is configured to transmit the long-lived SMS communication 46 to the vehicle's electronic controller 20 when the vehicle 10 is within transmitting range 49 of, such as is in a predetermined proximity to, or passes by a respective cellular tower (shown as tower 48-1). Upon receipt of the long-lived SMS communication 46 by the vehicle's electronic controller 20 and in response thereto, the vehicle controller is configured to trigger an emergency vehicle action 50. The long-lived SMS communication 46 may include instructions for the emergency vehicle action 50 to be taken internal and/or external to the vehicle 10. Such instructions may be audible and/or visual sensory signals or alerts. For example, the instructions for an emergency vehicle action 50 internal to the vehicle may include activating at least one of a high-volume noise (via vehicle speakers) and displaying a visual message (via the navigation screen) of the infotainment system 30. On the other hand, instructions for an emergency vehicle action 50 external to the vehicle 10 may, for instance, include honking the vehicle's horn and/or activating a flashing light pattern via the vehicle lighting system 52.

Meanwhile, the remote vehicle service provider 42 may also be configured to identify geographic location 54 of the cellular tower 48-1 having transmitted the long-lived SMS communication 46 to the vehicle's electronic controller 20 and time of the transmission. The remote vehicle service provider 42 may be additionally configured to communicate the cellular tower's geographic location 54 and time of the successful SMS transmission to a vehicle searching organization or authority 56, such as a pertinent law enforcement agency, to assist the authority with narrowing the geographical area for the vehicle search. The remote vehicle service provider 42 may be further configured to establish an aggressive packet connection 58 with the vehicle's electronic controller 20 following receiving thereby the long-lived SMS communication 46.

In the context of data transmission, a packet connection is a method of efficiently and reliably transferring data across a network, such as Wi-Fi, by breaking large data files down into smaller units, called packets. Typically, packets are transmitted independently across a network and then reassembled at the receiving end. Packet connection may be used by the vehicle's controller 20 to communicate with an external source, such as the vehicle service provider 42 via a mobile application. As compared to a normal packet connection with a mobile application, rather than a network transmission control protocol (TCP) making a preset or limited number of attempts (typically 2-3 times) to connect to an addressee, an aggressive packet connection is set up to continuously retry to connect until it succeeds.

The aggressive packet connection 58 may include instructions for an impaired or reduced operation 60 of the vehicle 10, such as a limp mode, park brake engaged, ignition lock, etc. The vehicle's electronic controller 20 may be configured to trigger the vehicle's impaired operation 60 in response to the aggressive packet connection 58 being established with the remote vehicle service provider 42. The remote vehicle service provider 42 may be additionally configured to receive communication 62 from the vehicle searching authority 56 indicative of the vehicle 10 having been recovered. In such a situation, the remote vehicle service provider 42 may be further configured to communicate to the vehicle's electronic controller 20 instructions 64 to reverse the triggered emergency vehicle action 50 and the impaired vehicle operation 60 when the vehicle 10 has been recovered. The vehicle's electronic controller 20 would then reverse or cancel the above actions in response to subject instructions 64.

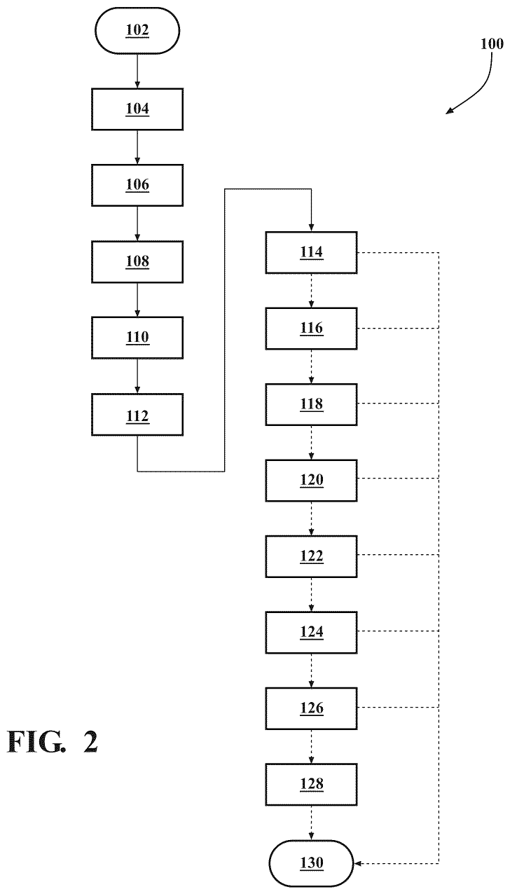

FIG. 2 depicts a method 100 of assisting recovery of a communication connectivity impaired vehicle, such as vehicle 10, using the system 40, as described above with respect to FIG. 1. The method 100 initiates in frame 102 with detecting, by the remote vehicle service provider 42, a loss of the vehicle's GPS connectivity, such as due to its cellular antenna 34 being rendered inoperative. Following frame 102, the method proceeds to frame 104. In frame 104, the method includes identifying, by the remote vehicle service provider 42, vehicle 10 as having been removed from its last known location without authorization of the vehicle's owner. As described above relative to the system 40, the remote vehicle service provider 42 may be informed of such an incident via a stolen vehicle police report or a phone call from the vehicle's owner. After frame 104, the method advances to frame 106.

In frame 106 the method includes sending, by the remote vehicle service provider 42, the long-lived SMS communication 46 to the mobile communication provider 44 in response to the identified loss or removal of the vehicle 10. Following frame 106, the method proceeds to frame 108. In frame 108, the method includes attaching, by the mobile communication provider 42, the long-lived SMS communication 46 to the network of cellular towers 48. As described above relative to the system 40, the long-lived SMS communication 46 may use a maximum time to live as active communication set by the mobile communication provider 44. After frame 108, the method proceeds to frame 110.

In frame 110, the method includes transmitting, via one of the cellular towers (such as the tower 48-1), the long-lived SMS communication 46 to the vehicle's electronic controller 20 when the vehicle 10 is within the transmitting range 49 of the subject cellular tower. Following frame 110, the method moves on to frame 112. In frame 112, the method includes receiving, via the vehicle's electronic controller 20, the long-lived SMS communication 46. Following frame 112, the method proceeds to frame 114. In frame 114, the method includes triggering, via the vehicle's electronic controller 20, emergency vehicle action 50 in response to the received long-lived SMS communication 46. As described above relative to the system 40, the long-lived SMS communication 46 may include instructions for the emergency vehicle action 50, including various actions taken internally to the vehicle 10, such as inside the cabin 12A to affect current vehicle occupier(s), and/or externally, such as to alert bystanders.

Following frame 114, the method may advance to frame 116 for identifying, by the remote vehicle service provider 42, geographic location 54 of the cellular tower (48-1) having transmitted the long-lived SMS communication 46 to the vehicle's electronic controller 20 and time of successful SMS transmission. After frame 116, the method may move on to frame 118 for communicating, by the remote vehicle service provider 42, the geographic location 54 of the subject cellular tower (48-1) and the time of SMS transmission to the vehicle searching authority 56. As noted previously, such information is intended to aid the vehicle searching authority 56 in locating the missing vehicle 10.

Following frame 118, and after the long-lived SMS communication 46 has been received by the vehicle's electronic controller 20, the method may proceed to frame 120. In frame 120, the method includes establishing, by the remote vehicle service provider 42, aggressive packet connection 58 with the vehicle's electronic controller 20. As described above relative to the system 40, the aggressive packet connection 58 includes instructions for impaired vehicle operation 60. After frame 120, i.e., following the aggressive packet connection 58 having been established, the method may move on to frame 122 for triggering, via the vehicle's electronic controller 20, the impaired vehicle operation 60.

Following frame 122, the method may advance to frame 124. In frame 124, the method includes receiving communication, via the remote vehicle service provider 42 from the vehicle searching authority 56, indicative of the vehicle 10 having been recovered. After frame 124, the method may move on to frame 126 for communicating, by the remote vehicle service provider 42 to the vehicle's electronic controller 20, instructions 64 to reverse the triggered emergency vehicle action 50 and the impaired vehicle operation 60 when the vehicle 10 has been recovered. In response to receiving subject instructions 64, the method would proceed to frame 128 where the vehicle's electronic controller 20 would reverse or cancel the previously taken vehicle actions. Following either frame 114, 118, 122, 126, or 128, the method may conclude in frame 130.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method of assisting recovery of a communication connectivity impaired vehicle having an electronic controller, the method comprising:
detecting, by a remote vehicle service provider configured to maintain communication with the vehicle's electronic controller via a global positioning system (GPS), a loss of global positioning system (GPS) connectivity with the vehicle;
identifying, by the remote vehicle service provider, the vehicle as having been removed from last known location without authorization of an owner of the vehicle;
sending, by the remote vehicle service provider, a long-lived short message service (SMS) communication to a mobile communication provider in response to the identified removal of the vehicle;
attaching, by the mobile communication provider, the long-lived SMS communication to a network of cellular towers;
transmitting, via one of the cellular towers, the long-lived SMS communication to the vehicle's electronic controller when the vehicle is within transmitting range of the subject cellular tower;
receiving, via the vehicle's electronic controller, the long-lived SMS communication; and
triggering, via the vehicle's electronic controller, an emergency vehicle action in response to the received long-lived SMS communication.

2. The method according to claim 1, wherein the long-lived SMS communication uses a maximum time to live as active communication set by the mobile communication provider.

3. The method according to claim 1, further comprising:
identifying, by the remote vehicle service provider, geographic location of the cellular tower having transmitted the long-lived SMS communication to the vehicle's electronic controller; and
communicating, by the remote vehicle service provider, the geographic location of the subject cellular tower to a vehicle searching authority.

4. The method according to claim 3, wherein the long-lived SMS communication includes instructions for the emergency vehicle action at least one of internal and external to the vehicle.

5. The method according to claim 4, wherein triggering the emergency vehicle action internal to the vehicle includes activating at least one of a high-volume noise and displaying a visual message via an infotainment system of the vehicle.

6. The method according to claim 4, wherein triggering the emergency vehicle action external to the vehicle includes activating at least one of honking a horn of the vehicle and activating a flashing light pattern via a lighting system of the vehicle.

7. The method according to claim 4, further comprising establishing, by the remote vehicle service provider, an aggressive packet connection with the vehicle's electronic controller following receiving thereby the long-lived SMS communication.

8. The method according to claim 7, wherein the aggressive packet connection includes instructions for an impaired vehicle operation, the method further comprising triggering, via the vehicle's electronic controller, the impaired vehicle operation in response to the aggressive packet connection being established.

9. The method according to claim 8, further comprising:
receiving communication, via the remote vehicle service provider from the vehicle searching authority, indicative of the vehicle having been recovered; and
communicating, by the remote vehicle service provider to the vehicle's electronic controller, instructions to reverse the triggered emergency vehicle action and the impaired vehicle operation when the vehicle has been recovered.

10. The method according to claim 1, wherein the loss of the vehicle's GPS connectivity is caused by a cellular antenna of the vehicle being rendered inoperative.

11. A system for assisting recovery of a communication connectivity impaired vehicle having an electronic controller, the system comprising:
a remote vehicle service provider configured to:
maintain communication with the vehicle's electronic controller via a global positioning system (GPS);
detect a loss of GPS connectivity with the vehicle;
identify the vehicle as having been removed from last known location without authorization of an owner of the vehicle;
send a long-lived short message service (SMS) communication to a mobile communication provider in response to the identified removal of the vehicle;
wherein the mobile communication provider is configured to attach the long-lived SMS communication to a network of cellular towers;
wherein each of the cellular towers is configured to transmit the long-lived SMS communication to the vehicle's electronic controller when the vehicle is within transmitting range of a respective cellular tower; and
wherein the vehicle's electronic controller is configured to:
receive the long-lived SMS communication; and
trigger an emergency vehicle action in response to the received long-lived SMS communication.

12. The system according to claim 11, wherein the long-lived SMS communication uses a maximum time to live as active communication set by the mobile communication provider.

13. The system according to claim 11, wherein the remote vehicle service provider is additionally configured to:
identify geographic location of the cellular tower having transmitted the long-lived SMS communication to the vehicle's electronic controller; and
communicate the geographic location of the subject cellular tower to a vehicle searching authority.

14. The system according to claim 13, wherein the long-lived SMS communication includes instructions for the emergency vehicle action at least one of internal and external to the vehicle.

15. The system according to claim 14, wherein the emergency vehicle action internal to the vehicle includes activating at least one of a high-volume noise and displaying a visual message via an infotainment system of the vehicle.

16. The system according to claim 14, wherein the emergency vehicle action external to the vehicle includes activating at least one of honking a horn of the vehicle and activating a flashing light pattern via a lighting system of the vehicle.

17. The system according to claim 14, wherein the remote vehicle service provider is additionally configured to establish an aggressive packet connection with the vehicle's electronic controller following receiving thereby the long-lived SMS communication.

18. The system according to claim 17, wherein the aggressive packet connection includes instructions for an impaired operation of the vehicle, and wherein the vehicle's electronic controller is additionally configured to trigger the impaired operation of the vehicle in response to the aggressive packet connection being established.

19. The system according to claim 18, wherein the remote vehicle service provider is additionally configured to:
receive communication from the vehicle searching authority indicative of the vehicle having been recovered; and
communicate, to the vehicle's electronic controller, instructions to reverse the triggered emergency vehicle action and the impaired vehicle operation when the vehicle has been recovered.

20. A method of assisting recovery of a communication connectivity impaired vehicle having an electronic controller, the method comprising:
detecting, by a remote vehicle service provider configured to maintain communication with the vehicle's electronic controller via a global positioning system (GPS), a loss of GPS connectivity with the vehicle caused by a cellular antenna of the vehicle being rendered inoperative;
identifying, by the remote vehicle service provider, the vehicle as having been removed from last known location without authorization of an owner of the vehicle;
sending, by the remote vehicle service provider, a long-lived short message service (SMS) communication to a mobile communication provider in response to the identified removal of the vehicle;
attaching, by the mobile communication provider, the long-lived SMS communication to a network of cellular towers;
transmitting, via one of the cellular towers, the long-lived SMS communication to the vehicle's electronic controller when the vehicle is within transmitting range of the subject cellular tower;
receiving, via the vehicle's electronic controller, the long-lived SMS communication;
triggering, via the vehicle's electronic controller, an emergency vehicle action in response to the received long-lived SMS communication;
identifying, by the remote vehicle service provider, geographic location of the cellular tower having transmitted the long-lived SMS communication to the vehicle's electronic controller;
communicating, by the remote vehicle service provider, the geographic location of the subject cellular tower to a vehicle searching authority; and
establishing, by the remote vehicle service provider, an aggressive packet connection with the vehicle's electronic controller following receiving thereby the long-lived SMS communication.
